(19) United States
(12) Patent Application Publication
(10) Pub. No.: US 2023/0208151 A1
(43) Pub. Date: Jun. 29, 2023

(54) Battery Unit, Method, and Apparatus for Operating the Battery Unit

(71) Applicant: Vitesco Technologies GmbH, Regensburg (DE)

(72) Inventor: Ayman Ayad, Regensburg (DE)

(73) Assignee: Vitesco Technologies GmbH, Regensburg (DE)

(21) Appl. No.: 18/069,274

(22) Filed: Dec. 21, 2022

(30) Foreign Application Priority Data
Dec. 23, 2021 (DE) 10 2021 214 976.6

(51) Int. Cl. H02J 7/00; H02M 3/335; H01M 50/51; H01M 10/42; B60L 50/60; B60L 58/12; B60L 58/16; B60L 58/22

(52) U.S. Cl. CPC H02J 7/0016; H02J 7/0019; H02J 7/0047; H02M 3/33584; H01M 50/51; H01M 10/425; B60L 50/60; B60L 58/12; B60L 58/16; B60L 58/22; H02J 2207/20; H01M 2010/4271; B60L 2210/12; B60L 2210/14; B60L 2200/10

(57) ABSTRACT

Various embodiments of the teachings herein include a battery unit comprising a string of battery modules in series. Each battery module includes a plurality of battery cells in series. Each battery module comprises a respective balancing circuit and a respective power electronics unit with a first DC/DC converter. The respective battery modules are connected in series via the respective power electronics unit. In each battery module, the first DC/DC converter comprises: an input port with two input terminals connected to the battery cells; an output port with two output terminals providing an output voltage; and a power supply port receiving power for the first DC/DC converter from the balancing circuit. The first DC/DC converter sets the output voltage of the battery module to a predetermined value. The balancing circuit extracts energy from a selected battery cells and provides it to the first DC/DC converter or the power electronics unit.

### CROSS-REFERENCE TO RELATED APPLICATIONS

This application claims priority to DE Application No. 10 2021 214 976.6 filed Dec. 23, 2021, the contents of which are hereby incorporated by reference in their entirety.

### TECHNICAL FIELD

The present disclosure relates to a battery unit. Various embodiments of the teachings herein include battery systems, electrical vehicles, computer programs, and/or computer readable media.

### BACKGROUND

A high voltage battery pack of a battery electric vehicle or a plug-in hybrid electric vehicle is typically built by grouping battery cells in parallel and/or in series to compose battery cell modules. These modules are then electrically connected in series to provide a required high voltage on a DC link of the battery pack.

In order to increase a maximum usable total power of battery cell modules the battery cells of the modules can be balanced or symmetrized. Balancing techniques mainly can be categorized into two categories: passive and active balancing. Passive balancing is achieved by discharging individual battery cells by means of a resistor connected in parallel with the battery cell. Normally, passive balancing is very cheap but takes a long time. In active balancing, an active charge transfer takes place, in which charge is removed from selected individual battery cells with a higher state of charge and feed to selected individual battery cells with a lower state of charge. Active balancing is very efficient and fast but, because of the additional hardware, expensive to be implemented.

### SUMMARY

Teachings of the present disclosure described battery units which can be flexible operated and efficiently balanced. For example, some embodiments of the teachings herein include a battery unit (10) comprising at least one string (3) of battery modules (2) electrically connected in series, each battery module (2) comprising a plurality of battery cells (4) electrically connected in series, wherein each battery module (2) of a group of battery modules (2) of the at least one string (3) of battery modules (2) comprises a balancing circuit (15) and a power electronics unit (14) with a first DC/DC converter (16) and the battery modules (2) of the group of battery modules (2) are electrically connected in series via their power electronics unit (14) and wherein in each battery module (2) of the group of battery modules (2) the first DC/DC converter (16) comprises an input port with two input terminals (IN1, IN2) connected to the battery cells (4) of the battery module (2), an output port with two output terminals (OUT1, OUT2) on which an output voltage of the battery module (2) is provided and a power supply port (P1, P2) on which a power supply for the first DC/DC converter (16) is provided by the balancing circuit (15), the first DC/DC converter (16) is configured to set the output voltage of the battery module (2) to a predetermined value, the balancing circuit (15) is configured to extract energy from a selected battery cell or battery cells and to provide the energy at least partly as power supply to the first DC/DC converter (16) or the power electronics unit (14).

In some embodiments, the respective balancing circuit (15) comprises a switch matrix (18) and a second DC/DC converter (17), wherein the switch matrix (18) comprises multiple switches for selectively connecting and disconnecting the battery cells (4) in the battery module (2) to the second DC/DC converter (17) to control discharging of the battery cells (4) in the battery module (2) and the second DC/DC converter (17) is configured to extract energy from a selected battery cell or selected battery cells, which are coupled to the second DC/DC (17) converter via the switch matrix (18) and to provide the energy at least partly as the power supply to the first DC/DC converter (16) or the power electronics unit (14), respectively.

In some embodiments, the respective switch matrix (18) comprises multiple switches for connecting a first pole of each battery cell (4) with a first input terminal (T1) of the second DC/DC converter (17) and a second pole of each battery cell (4) with a second input terminal (T2) of the second DC/DC converter (17).

In some embodiments, the respective second DC/DC converter (17) is an isolated bi-directional DC/DC converter.

In some embodiments, the respective first DC/DC converter (16) is configured to operate in buck mode and/or boost mode and/or bypass mode to bypass the respective battery module (2) and/or path-through mode to connect a DC link circuit directly to the respective battery module (2).

In some embodiments, for at least one battery module (2) of the group of battery modules (2) one or multiple battery cells (4) of the respective battery module (2) are selected dependent on received measurement values for the battery cells (4) of this battery module (2), wherein the respective measurement values are each representative for a state of charge of a battery cell and/or battery cell voltage and/or a state of health of a battery cell, and at least one balancing control signal is generated and provided for the balancing circuit (15) such that the balancing circuit (15) extracts energy from a selected battery cell/cells and provides the energy at least partly as power supply to the first DC/DC converter (16) or the power electronics unit (14).

In some embodiments, the at least one balancing control signal comprises a first control signal and a second control signal and the first control signal is generated and provided for the switch matrix (18), such that the switch matrix (18) connects the selected battery cell/cells with the second DC/DC converter (17) in a pre-defined manner and the second control signal is generated and provided for the second DC/DC converter (17), such that the second DC/DC converter (17) discharges the selected battery cell/cells with a pre-defined current and provides a pre-defined supply voltage on the power supply port (P1,P2) of the first DC/DC converter (16) or the power electronics unit (14), respectively.

In some embodiments, the apparatus (11) is configured to perform a method as described herein.

As another example, some embodiments include a battery system (1) comprising a battery unit (10) and an apparatus (11) as described herein. As another example, some embodiments include an electric vehicle comprising a battery system as described herein.

As another example, some embodiments include a computer program which, when executed by a processor of a battery management apparatus, causes the battery management apparatus to perform one or more of the methods as described herein.

As another example, some embodiments include a computer readable medium comprising a computer program which, when the program is executed by a processor of a battery management apparatus, causes the battery management apparatus to perform one or more of the methods described herein.

### BRIEF DESCRIPTION OF THE DRAWINGS

It is to be understood that both the foregoing general description and the following detailed description are merely exemplary and are intended to provide an overview or framework to understand the nature and character of the teachings herein. The accompanying drawings are included to provide further understanding. The drawings illustrate one or more embodiments, and together with the description serve to explain principles and operation of the various embodiments. The same elements in different figures of the drawings are denoted by the same reference signs. The drawings are not necessarily drawn to scale but are configured to clearly illustrate the disclosure.

FIG. 1 shows an exemplary embodiment of a battery system for an electric vehicle incorporating teachings of the present disclosure;

FIG. 2 shows an exemplary embodiment of a battery module incorporating teachings of the present disclosure;

FIG. 3 shows an exemplary embodiment of a first DC/DC converter incorporating teachings of the present disclosure; and

FIG. 4 shows an exemplary embodiment of a flow chart for a program incorporating teachings of the present disclosure.

### DETAILED DESCRIPTION

The present disclosure describes various battery units. The battery unit maybe for an electric vehicle. In some embodiments, the battery unit may also be configured to be used in airplanes, charging stations, or big storage systems or even in small systems, like portable devices.

The battery unit comprises at least one string of battery modules electrically connected in series. Each battery module comprises a plurality of battery cells electrically connected in series. In some embodiments, a battery cell may represent a pack of second battery cells which are connected in parallel.

Each battery module of a group of battery modules of the at least one string of battery modules comprises a balancing circuit and a power electronics unit with a first DC/DC converter. The battery modules of the group of battery modules are electrically connected in series via their power electronics unit. In some embodiments, the group of battery modules comprises multiple battery modules or all battery modules of the at least one string.

In the following, a battery module of the group of battery modules is called first battery module. The first DC/DC converter of a first battery module comprises an input port with two input terminals connected to the battery cells of the first battery module, an output port with two output terminals on which the output voltage of the first battery module is provided and a power supply port on which a power supply for the first DC/DC converter is provided by the balancing circuit of the first battery module. The first DC/DC converter of the first battery module is configured to set the output voltage of the first battery module to a predetermined value.

The balancing circuit of the first battery module is configured to extract energy from a selected battery cell or battery cells of the first battery module to provide the energy at least partly as power supply to the power electronics unit. In some embodiments, the balancing circuit of the first battery module is configured to extract energy from the selected battery cell or battery cells of the first battery module and to provide the energy at least partly as power supply to the first DC/DC converter only. This may provide that the entire energy of the battery cells can be fully utilized for powering the power electronics unit or the first DC/DC converter, respectively. In addition, the balancing between the battery cells can be done during operation and no energy is wasted.

In some embodiments, the balancing circuit of the respective first battery module comprises a switch matrix and a second DC/DC converter. The switch matrix comprises multiple switches for selectively connecting and disconnecting the battery cells in the first battery module to the second DC/DC converter of the first battery module to control discharging of the battery cells in the first battery module. The second DC/DC converter is configured to extract energy from a selected battery cell or selected battery cells of the first battery module, which are connected to the second DC/DC converter via the switch matrix, and to provide the energy at least partly as the power supply for the power electronics unit of the first battery module or to the first DC/DC converter of the first battery module, respectively.

In some embodiments, the second DC/DC converter is configured to extract power from a selected battery cell or selected battery cells and to supply the first DC/DC converter with 12 volt until it/they is/are in balance with the other battery cells.

In some embodiments, the switch matrix of the respective first battery module comprises multiple switches for connecting a first pole of each battery cell with a first input terminal of the second DC/DC converter and for connecting a second pole of each battery cell with a second input terminal of the second DC/DC converter. This allows to connect any desired group of battery cells to the input port of the second DC/DC converter dependent on provided control signals for the switches.

In some embodiments, the second DC/DC converter of the respective first battery module is an isolated bi-directional DC/DC converter. This allows using different ground than the ground of the first DC/DC converter.

In some embodiments, the first DC/DC converter of the respective first battery module is configured to operate in buck mode and/or boost mode and/or bypass mode to bypass the respective battery module and/or path-through mode to connect a DC link circuit directly to the respective battery module, in particular to the battery cell pack of the battery module.

This structure and configuration of the first battery modules and first DC/DC converters allows to operate the first battery modules in a very flexible manner. This flexibility can be used for voltage and/or state of charge balancing of the first battery modules and for optimizing in view of provided energy or power. Different modes of the first battery modules can be selected dependent on, for example, age, chemistry, manufacture, and size of the battery cells of the first battery modules.

In some embodiments, there is a method and an apparatus for operating a battery unit as described herein. For at least one battery module of the group of battery modules, i.e., for at least one first battery module, one or multiple battery cells of the respective first battery module are selected dependent on received measurement values for the battery cells of this first battery module, wherein the respective measurement values are each representative for a state of charge of a battery cell and/or a battery cell voltage and/or a state of health. At least one balancing control signal is generated and provided for the balancing circuit such that the balancing circuit of the first battery module extracts energy from a selected battery cell/cells of the first battery module and provides the energy at least partly as power supply to the power electronics unit or to the first DC/DC converter.

In some embodiments, the at least one balancing control signal comprises a first control signal and a second control signal. The first control signal is generated and provided for the switch matrix, such that switch matrix connects the selected battery cells with the second DC/DC converter in a pre-defined manner. The second control signal is generated and provided for the second DC/DC converter, such that the second DC/DC converter discharges the selected battery cells with a pre-defined current and provides a pre-defined supply voltage on the power supply port of the first DC/DC converter or the power electronics unit, respectively.

Some embodiments include an electric vehicle comprising a battery system as described herein. In this disclosure an electric vehicle is a vehicle which comprises an electric drive. So, an electric vehicle according to this disclosure may include a pure electric vehicle, sometimes also called battery electric vehicle (“BEV”), or a hybrid electric vehicle (“HEV”), in particular a plug-in hybrid electric vehicle (“PHEV”).

Some embodiments include a computer program which, when executed by a processor of a battery management apparatus, causes the battery management apparatus to perform one or more of the methods described herein. The computer program may be implemented as computer readable instruction code in any suitable programming language such as JAVA, C++, etc. The computer program may be stored on a computer-readable storage medium (CD-Rom, DVD, Blu-ray disc, removable drive, volatile or non-volatile memory, built-in memory/processor, etc.). The instruction code may program a computer or other programmable device, such as, in particular, a control unit for a battery of an electric vehicle, such that the desired functions are performed. Further, the computer program may be provided on a network, such as the Internet, from which it may be downloaded by a user or automatically, as needed.

Some embodiments include a computer readable medium comprising a computer program which, when the program is executed by a processor of a battery management apparatus, causes the battery management apparatus to perform one or more of the methods described herein.

The teachings of the present disclosure may be implemented both by means of a computer program, i.e., software, and by means of one or more special electrical circuits, i.e., hardware, or in any hybrid form, i.e., by means of software components and hardware components.

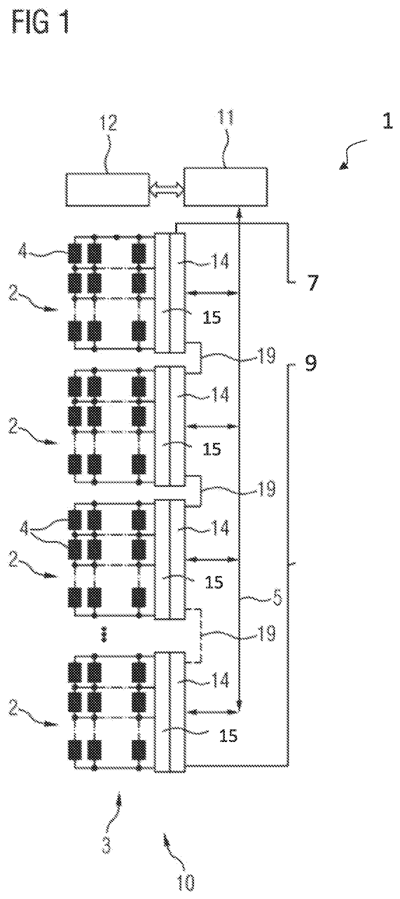

FIG. 1 shows an exemplary battery system 1, for instance, for an electric vehicle incorporating teachings of the present disclosure. The battery system 1 comprises a battery unit 10 and an apparatus 11 for operating the battery unit 10. The apparatus 11 for operating the battery unit 10 may also be named battery management system. The apparatus 11 for operating the battery unit 10 comprises, for example, a battery management controller with a microprocessor or microcontroller. The battery unit 10 may also be named battery pack. The apparatus 11 for operating the battery unit 10 is for example configured to communicate with a vehicle control unit 12.

In some embodiments, the battery unit 10 comprises a plurality of battery modules 2. The battery modules 2 are electrically connected in series to form a string 3. In the embodiment shown in FIG. 1, the battery unit 10 comprises only one string 3. In some embodiments, the battery unit 10 may comprise more than one string 3 of battery modules 2. The string 3 of battery modules 2 provides a DC link voltage between main connectors 7, 9 of the battery unit 10. A nominal voltage of each battery module 2 is for example 48 V.

The battery modules 2 comprise multiple battery cells 4, which are electrically connected in series to form a battery module 2. According to disclosure a battery cell 4 may comprise a pack of second battery cells which are connected in parallel.

In addition, the battery modules 2 each comprise a power electronics unit 14. The battery modules 2 are electrically connected in series via their power electronics units 14, which is indicated by connection 19 in FIG. 1.

Each power electronics unit 14 comprises a first DC/DC converter 16 (direct current-to-direct current converter). For instance, the first DC/DC converters 16 are configured to set the output voltage of the respective battery module 2 to a predetermined value. Optionally, the first DC/DC converters 16 maybe controlled to bypass certain modules 2, if necessary. To achieve this, the first DC/DC converters 16 of the power electronics units 14 are operable in a buck and in a boost mode and may also be operable in path-through mode and in bypass mode.

The first DC/DC converters 16 each have an input port with two input terminals IN1, IN2 and an output port with two output terminals OUT1, OUT2. The input terminals IN1, IN2 are electrically connected to the battery cells 4 of the respective battery module 2 and the output terminals OUT1, OUT2 are electrically connected in series to the next, i.e. the subsequent and the preceding, battery modules 2 of the string 3. Thus, the battery modules 2 are electrically connected in series via their power electronics units 14.

In some embodiments, the power electronics units 14 comprise switches operable by a control unit for switching the respective battery module 2 into a bypass mode or a path-through mode. In the bypass mode, the DC link bypasses the respective module, i.e. the respective module does not contribute to the DC link voltage on main connectors 7, 9. In pass-through mode, the connection is routed through to the battery module 2 without the first DC/DC converter 16 affecting an output voltage of the battery module 2.

This battery system 1 with battery modules 2 each having such a power electronics unit 14 has the advantage, that, when driving the electric vehicle the current drawn from each of the battery modules 2 can be optimised to ensure an even load of the battery modules 2. Furthermore, it is possible to charge the battery unit 10 either from a 400V or 800V charging station. Because of the first DC/DC converters 16, the voltage can be boosted on the DC-link side to a higher value.

Performance can be maintained even in the case of a low state of charge of some modules by adding more modules in series.

The different modes of operation of the first DC/DC converters 16, i.e. in particular the bypass mode and the path-through mode, have the advantage that individual battery modules 2 can be switched on and off to contribute to the voltage supply not to contribute. This makes it possible to use the battery unit 10 very flexibly and to supply different voltage levels. This fully switchable battery unit 10 allows e.g. to replace the separate low voltage supply of the electric vehicle by supplying 48 V or 12 V from individual battery modules 2 of the battery unit 10. Furthermore, a low voltage supplied by only one or only a few battery modules 2 can be used to pre-charge a DC link capacitor. Hence, the battery unit 10 can be used very flexibly to replace other components of the vehicle.

In addition, at least some of the battery modules 2 of the string 3 comprise a balancing circuit 15 configured to extract energy from a selected battery cell or battery cells, to provide the energy at least partly as power supply to the first DC/DC converter 16. The balancing circuit 15 is configured to supply, for example, a supply voltage of 12 volt that is needed by the first DC/DC converter 16. In some embodiments, all battery modules 2 of the string 3 comprise such a balancing circuit.

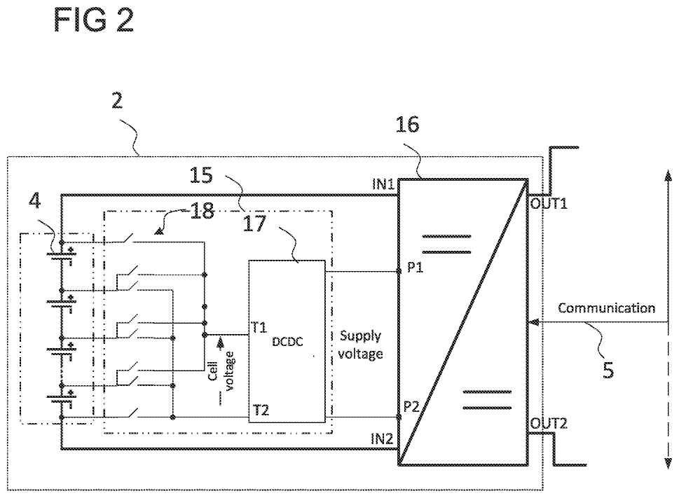

An exemplary embodiment of one of these battery modules 2 is shown in FIG. 2. The balancing circuit 15 comprises for example a switch matrix 18 and a second DC/DC converter 17. The switch matrix 18 comprises multiple switches for selectively connecting or disconnecting, respectively, the battery cells 4 in the battery module 2 to the second DC/DC converter 17 to control discharging of the battery cells 4 in the battery module 2.

The switch matrix 18 comprises multiple switches for connecting a first pole of each battery cell 4 with a first input terminal T1 of the second DC/DC converter 17 and a second pole of each battery cell 4 with a second input terminal T2 of the second DC/DC converter 17.

In some embodiments, the switch matrix 18 comprises for each battery cell 4 a first switch for connecting the first pole of the respective battery cell 4 with the first input terminal T1 of the second DC/DC converter 17 and a second switch for connecting the second pole of the respective battery cell 4 with the second input terminal T2 of the second DC/DC converter 17.

The second DC/DC converter 17 comprises an output port with a first output terminal which is connected to a first power supply terminal P1 of the first DC/DC converter 16 and a second output terminal which is connected to the second power supply terminal P2 of the first DC/DC converter 16.

The second DC/DC converter 17 is configured to extract energy from a selected battery cell or battery cells, which are coupled to the second DC/DC converter 17 via the switch matrix 18 and to provide the energy at least partly as power supply to the first DC/DC converter 16.

The switch matrix 18 can be controlled to connect a battery cell/battery cells 4 that has/have higher state of charges (SoCs) to the second DC/DC converter 17 and the second DC/DC converter 17 boosts/bucks the voltage to, for example, 12 volt to supply the first DC/DC converter 16.

In some embodiments, the second DC/DC converter 17 is, for example, an isolated bi-directional DC/DC converter. The second DC/DC converter 17 may be a multi-phase converter where each phase is connectable to one battery cell 4. This allows that any battery cell 4 or any group of battery cells 4 of the battery module 2 can be selected for discharging.

In some embodiments, the balancing circuit 15 may comprise a battery cell supervision circuit. The battery cell supervision circuit may be configured to measure a voltage of each battery cell and two or three battery cell temperatures per battery module 2. These measurements maybe sent to the apparatus 11 for operating the battery unit 10 to estimate the state of charge of each battery cell 4. For instance, the apparatus 11 for operating the battery unit 10 is configured to determine which battery cells 4 need to be discharged/balanced.

In some embodiments, the battery module 2 comprises, for example, a communication interface 5 to communicate with the apparatus 11 of the battery system 1 to transmit control instructions.

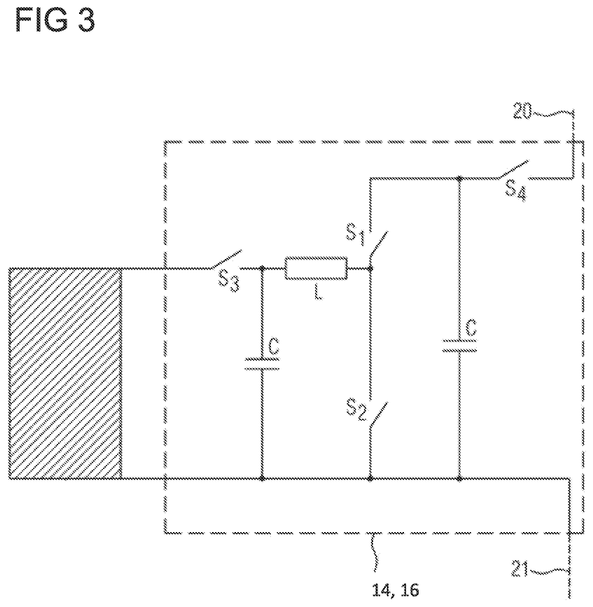

FIG. 3 shows an exemplary embodiment of a battery module 2 of the battery unit 10 shown in FIG. 1 and its power electronics unit 14. The power electronics unit 14 comprises the first DC/DC converter 16 and optionally additional switches S3, S4 to control different modes of operation of the first DC/DC converter 16. The first DC/DC converter 16 is configured to operate at least in buck mode and boost mode. Optionally, the first DC/DC converter 16 is configured to operate in pass mode to bypass the respective battery module 2 and/or in path-through mode to connect a DC link circuit directly to the respective battery module 2.

In a buck/boost mode, switches S3 and S4 are on and switches S1 and S2 are switching. In the buck/boost mode, the voltage drop between terminals 20 and 21 can be set to a predetermined voltage according to a state of charge of the battery module 2 and according to a demand from the apparatus 11 for operating the battery unit 10.

In a bypass mode, switches S1, S2 and S4 are on and switch S3 is off, so that the battery module 2 is bypassed. This mode can be chosen, when a certain battery module 2 is defective.

If the required voltage on the DC-link side is equal to the battery cell voltages, the DC/DC operates in path-through mode. In a path-through mode, switches S1, S3 and S4 are on and switch S2 is off. In this mode, the battery module 2 is operated in a conventional mode without adjusting the output voltage.

Furthermore, the first DC/DC converter 16 can be operated in a standby mode, where switches S1 and S2 are off and switches S3 and S4 are on, and in an open circuit mode, in which all switches are off and no high voltage is present.

The switches S1, S2, S3 and S4 are controlled by the apparatus 11 for operating the battery unit 10.

In some embodiments, the power electronics unit 14 may comprise a microcontroller (not shown in FIG. 3). The microcontroller may be configured to control the output voltage of the first DC/DC converter 16 and to keep the current and voltages within predefined ranges. For example, the microcontroller is configured to receive a set-point and the modes of operation from the apparatus 11, and to control switches of the first DC/DC converter 16 accordingly, and to send feedback (for example, recorded discharge currents and/or battery cell voltages and/or etc.) to the apparatus 11.

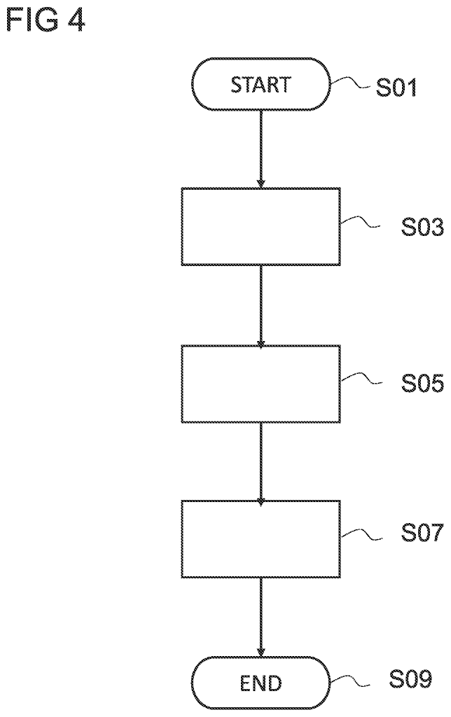

FIG. 4 shows an exemplary embodiment of a flow chart of a program for operating a battery unit 10 of an electric vehicle. The program steps may be performed for each battery module 2 of the group of battery modules 2 of the at least one string 3 of battery modules 2 which comprise a balancing circuit 15 configured to provide the supply voltage for the first DC/DC converter 16.

The program may run on a processor of the apparatus 11 for operating the battery unit 10. The apparatus 11 for operating the battery unit 10 may comprise a distributed hardware and/or software architecture. Thus, the processor may be arranged in the electrical vehicle or outside of the vehicle.

In a step S01, the program is started. Furthermore, in step S01, for example, program variables are initialized. In some embodiments, the start of the program may be caused by a trigger signal. The trigger signal is, for example, generated in response to a request of starting or charging the electric vehicle. The trigger signal may be sent by the vehicle control unit 12.

In a step S03, for example, dependent on a power request received from the vehicle control unit 12, the mode of operation of the battery modules 2 is determined and the power consumption is determined.

In a step S05, dependent on the determined power consumption of the respective battery module 2 and recorded battery cell measurement values for this respective battery module 2 one or multiple battery cells 4 of the respective battery module 2 are determined and, for instance, a discharge current of the battery cells 4 of this respective battery module is determined. The recorded battery cell measurement values may be representative for state of charges of the battery cells 4 of this respective battery module 2 and/or for battery cell voltages of the battery cells 4 of this respective battery module 2 and/or state of health of the battery cells 4 of this respective battery module 2.

In a step S07, a first control signal is generated and provided for the switch matrix 18, such that switch matrix 18 connects the selected battery cells with the second DC/DC converter 17 in a pre-defined manner. Because of the flexibility of the switch-matrix, for example only one battery cell 4 may be connected with its plus pole to the first input terminal T1 of the second DC/DC converter 17 and with its minus pole to the second input terminal T2 of the second DC/DC converter 17. In another case, a subset of battery cells 4 of the battery module 2 which are connected in series, are connected to the input port T1, T2 of the second DC/DC converter 17.

Furthermore, in step S07 a second control signal is generated and provided for the second DC/DC converter 17, such that the second DC/DC converter 17 discharges the selected battery cells with a pre-defined current and provides a pre-defined supply voltage on the power supply port of the first DC/DC converter 16.

For example, the procedure is repeated until the electric vehicle is parked again. In case of parking the electric vehicle the program is terminated in step S09.

### REFERENCE SIGNS

1 battery system

2 battery module

3 string of battery modules

4 battery cell

5 communication interface

7,9 main connector

10 battery unit

11 apparatus for operating a battery unit

12 vehicle control unit

14 power electronics unit

15 balancing circuit

16 first DC/DC converter

17 second DC/DC converter

18 switch matrix

19 connection

20,21 terminals

IN1, IN2 input terminals of the first DC/DC converter

OUT1, output terminals of the first DC/DC converter

OUT2

P1, P2 power supply terminals of the first DC/DC converter

S01, . . . , program steps

S09

T1, T2 input terminals of the second DC/DC converter

1. A battery unit comprising:
a string of battery modules electrically connected in series, each battery module comprising a plurality of battery cells electrically connected in series, wherein each battery module of a group of battery modules comprises a respective balancing circuit and a respective power electronics unit with a first DC/DC converter, and the respective battery modules are electrically connected in series via the respective power electronics unit; and
wherein in each battery module, the first DC/DC converter comprises:
an input port with two input terminals connected to the battery cells;
an output port with two output terminals providing an output voltage; and
a power supply port receiving power for the first DC/DC converter from the balancing circuit;
wherein the first DC/DC converter sets the output voltage of the battery module to a predetermined value; and
the balancing circuit extracts energy from a selected battery cell or battery cells and provides the energy at least partly to the first DC/DC converter or the power electronics unit.

2. The battery unit according to claim 1, wherein:
each respective balancing circuit comprises a switch matrix and a second DC/DC converter;
the switch matrix comprises multiple switches for selectively connecting and disconnecting the battery cells in the battery module to the second DC/DC converter to control discharging of the battery cells in the battery module; and
the second DC/DC converter extracts energy from a selected battery cell or selected battery cells coupled to the second DC/DC converter via the switch matrix and provides the energy at least partly as the power supply to the first DC/DC converter or the power electronics unit, respectively.

3. The battery unit according to claim 2, wherein each respective switch matrix comprises multiple switches for connecting a first pole of each battery cell to a first input terminal of the second DC/DC converter and a second pole of each battery cell to a second input terminal of the second DC/DC converter.

4. The battery unit according to claim 2, wherein each respective second DC/DC converter comprises an isolated bi-directional DC/DC converter.

5. The battery unit according to claim 1, wherein the respective first DC/DC converter operates in buck mode and/or boost mode and/or bypass mode to bypass the respective battery module and/or path-through mode to connect a DC link circuit directly to the respective battery module.

6. A method for operating a battery unit, the method comprising:
selecting one battery cell of a plurality of battery cells in a first battery module dependent on received measurement values for the individual battery cells of the plurality of battery cells, wherein the respective measurement values each represent a state of charge of a battery cell, a battery cell voltage, and/or a state of health of a battery cell; and
generating a balancing control signal and providing the signal to a balancing circuit such that the balancing circuit extracts energy from the selected battery cell and provides the energy to a first DC/DC converter or a power electronics unit.

7. The method according to claim 6, wherein:
the balancing control signal comprises a first control signal and a second control signal;
the first control signal is sent to a switch matrix, such that the switch matrix connects the selected battery cell to a second DC/DC converter in a pre-defined manner; and
the second control signal is generated and sent to the second DC/DC converter, such that the second DC/DC converter discharges the selected battery cell/cells with a pre-defined current and provides a pre-defined supply voltage on a power supply port of the first DC/DC converter or the power electronics unit.

8. A non-transitory computer readable medium storing a computer program which, when the program is executed by a processor of a battery management apparatus, causes the battery management apparatus to:
select one battery cell of a plurality of battery cells in a first battery module dependent on received measurement values for the individual battery cells of the plurality of battery cells, wherein the respective measurement values each represent a state of charge of a battery cell, a battery cell voltage, and/or a state of health of a battery cell; and
generate a balancing control signal and providing the signal to a balancing circuit such that the balancing circuit extracts energy from the selected battery cell and provides the energy to a first DC/DC converter or a power electronics unit.
